(19) United States
(12) Patent Application Publication
(10) Pub. No.: US 2008/0242372 A1
(43) Pub. Date: Oct. 2, 2008

(54) ELECTRONIC DEVICE WITH LOCATION-BASED AND PRESENCE-BASED PHYSICAL ATTRIBUTES AND METHOD OF CONTROLLING SAME

(76) Inventors: Kurt Schmidt, Chapel Hill, NC (US); William O. Camp, Chapel Hill, NC (US); Scott Clagett, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/690,934

(22) Filed: Mar. 26, 2007

(51) Int. Cl. H04M 1/00

(52) U.S. Cl. 455/575.1

(57) ABSTRACT

A mobile telephone includes a radio circuit for establishing a call over a communications network. The mobile telephone also includes a housing that retains the radio circuit and an illumination assembly. The illumination assembly is controlled to generate light in a color having a user specified relationship to a location of the mobile telephone. In one embodiment, the illumination assembly is controlled to generate light in a color having a user specified relationship to an electronic device that is detected to be in relative proximity to the mobile telephone.

### TECHNICAL FIELD OF THE INVENTION

The present invention relates generally to portable electronic devices and, more particularly, to an electronic device that has attributes that change as the location of the electronic device changes and/or as other electronic devices enter or leave the vicinity of the electronic device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

The physical appearance of an electronic device may be a driving factor in a consumer's decision to purchase the electronic device over other electronic devices having similar functionality. Thus, product differentiation is sometimes viewed as desirable by distributors and retailers of consumer electronics. Also, many users perceive the ability to personalize an electronic device as being a high priority feature when making a purchasing decision.

### SUMMARY

To increase product differentiation among electronic devices and to increase the ability to personalize electronic devices, there is a need in the art for a device that changes physical attributes. The changes may be driven by the location of the electronic device and/or the proximity of other electronic devices to the electronic device. Further, these location-sensitive and/or presence-sensitive attributes may be based on user settings.

According to one aspect of the invention, a mobile telephone includes a radio circuit for establishing a call over a communications network; a housing that retains the radio circuit; and an illumination assembly retained by the housing and that is controlled to generate light in a color having a user specified relationship to a location of the mobile telephone.

According to an embodiment of the mobile telephone, the illumination assembly includes one or more illuminators disposed under a clear or translucent casing that at least partially covers the housing of the mobile telephone.

According to an embodiment of the mobile telephone, the illumination assembly includes one or more illuminators disclosed under a clear or translucent portion of the housing of the mobile telephone.

According to an embodiment of the mobile telephone, the illumination assembly includes a display disposed under a translucent member.

According to an embodiment of the mobile telephone, the display is a liquid crystal display.

According to an embodiment of the mobile telephone, the translucent member is touch sensitive and forms part of a touch-sensitive keypad.

According to one embodiment, the mobile telephone further includes a position data receiver for determining the location of the mobile telephone.

According to an embodiment of the mobile telephone, the illumination assembly is further controlled to generate light in a color having a user specified relationship to an electronic device that is detected to be in relative proximity to the mobile telephone.

According to another aspect of the invention, a method of controlling a physical attribute of a mobile telephone includes determining a location of the mobile telephone; and generating light with an illumination assembly of the mobile telephone in a color having a user specified relationship to the location of the mobile telephone.

According to one embodiment, the method further includes generating light with the illumination assembly in a color having a user specified relationship to an electronic device that is detected to be in relative proximity to the mobile telephone.

According to one embodiment, the method further includes generating light with the illumination assembly in a color having a user specified relationship to a time of day.

According to another aspect of the invention, a mobile telephone includes a radio circuit for establishing a call over a communications network; a housing that retains the radio circuit; and an illumination assembly retained by the housing and that is controlled to generate light in a color having a user specified relationship to an electronic device that is detected to be in relative proximity to the mobile telephone.

According to an embodiment of the mobile telephone, the color is based on an identity of a user associated with the electronic device.

According to an embodiment of the mobile telephone, the color is based on a number of electronic devices detected to be in relative proximity to the mobile telephone.

According to an embodiment of the mobile telephone, the illumination assembly includes one or more illuminators disposed under a clear or translucent casing that at least partially covers the housing of the mobile telephone.

According to an embodiment of the mobile telephone, the illumination assembly includes one or more illuminators disclosed under a clear or translucent portion of the housing of the mobile telephone.

According to another aspect of the invention, a method of controlling a physical attribute of a mobile telephone includes detecting presence of an electronic device having a known identity; and generating light with an illumination assembly of the mobile telephone in a color having a user specified relationship to the detected electronic device.

According to an embodiment of the method, the color is based on an identity of a user associated with the electronic device.

According to an embodiment of the method, the color is based on a number of known electronic devices detected to be in relative proximity to the mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of one embodiment of a mobile telephone as an exemplary electronic device in accordance with the present invention;

FIG. 2 is a schematic view of another embodiment of a mobile telephone as another exemplary electronic device in accordance with the present invention;

FIG. 3 is a schematic block diagram of the relevant portions of the mobile telephone embodiments of FIGS. 1 and 2;

FIG. 4 is a schematic diagram of a communications system in which the mobile telephone embodiments of FIGS. 1 and 2 may operate; and

FIG. 5 is a flow chart representing an exemplary method of controlling physical attributes of an electronic device.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

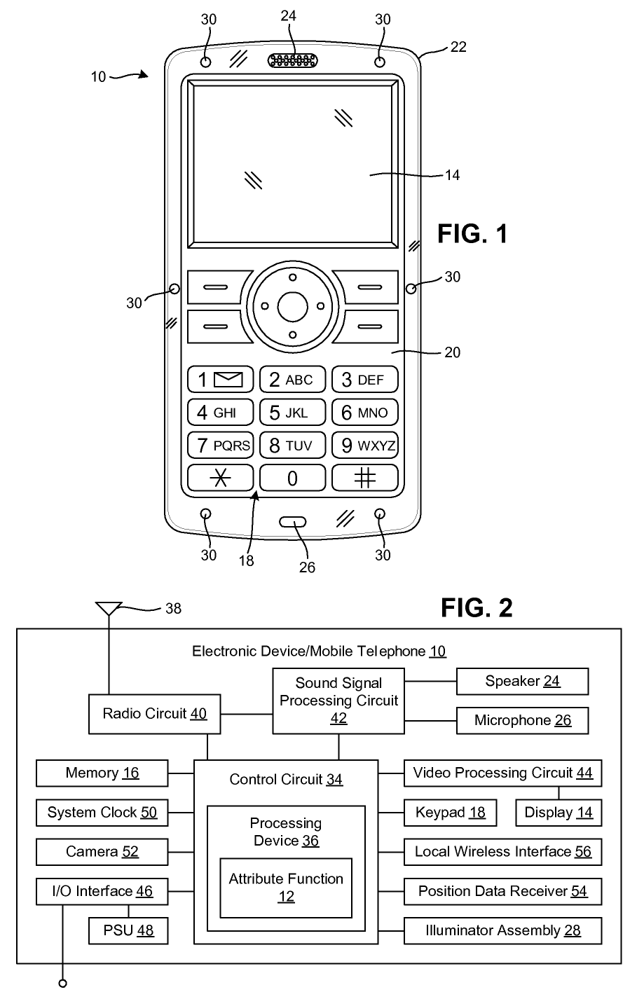

Referring initially to FIGS. 1 and 2, an exemplary electronic device 10 is shown. The electronic device 10 is configured to change physical attributes depending on the location of the electronic device 10 and/or depending on the presence of other electronic devices. The user may configure the conditions that trigger a change in the attributes and/or the nature of the attributes. In the illustrated embodiment, the color and/or lighting scheme of the electronic device 10 is configured to change.

The electronic device 10 may include an attribute function 12 that is configured to control the changeable physical attribute (or attributes) of the electronic device 10. Additional details and operation of the changeable attribute(s) and the attribute function 12 will be described in greater detail below. The attribute function 12 may be embodied as executable code that is resident in and executed by the electronic device 10. In one embodiment, the attribute function 12 may be a program stored on a computer or machine readable medium. The attribute function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

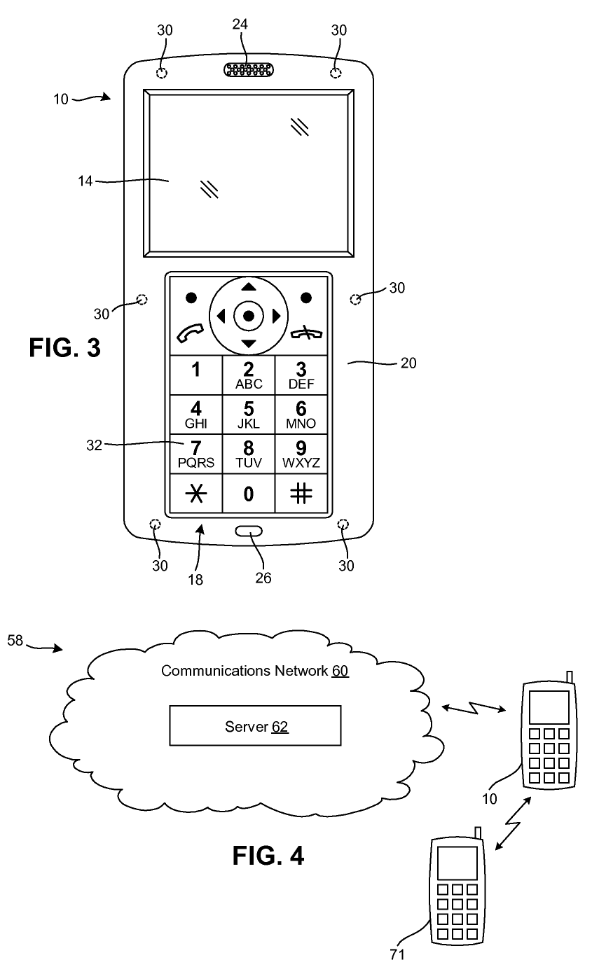

The mobile telephone 10 may include a display 14. The display 14 displays information to a user such as operating state, time, telephone numbers, contact information, various navigational menus, etc., which enable the user to utilize the various features of the mobile telephone 10. The display 14 also may be used to visually display content received by the mobile telephone 10 and/or retrieved from a memory 16 (FIG. 3) of the mobile telephone 10. The display 14 may be used to present images, video and other graphics to the user, such as photographs, mobile television content and video associated with games.

A keypad 18 provides for a variety of user input operations. For example, the keypad 18 typically includes alphanumeric keys for allowing entry of alphanumeric information such as telephone numbers, phone lists, contact information, notes, etc. In addition, the keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages (e.g., a text message is commonly referred to by some as “an SMS,” which stands for simple message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

In the embodiment of FIG. 1, the mobile telephone 10 has a housing 20. The housing 20 may be made from an opaque material, such as plastic or metal. Disposed over the housing 20 may be a casing 22. The casing 22 may be made from a rigid or a resilient material, and is preferably made from a clear material or a translucent material. In one embodiment, light may be fully or partially transmitted through the casing 22 material. Also, the casing 22 may function to guide light or diffuse light over the housing 20 so that regions and/or edges of the mobile telephone 10 may appear to be illuminated. The casing 22 may be an outer covering for the housing 20 that is easily removable from housing 20 by the user. In this manner, casings or various configurations, light transmissive properties or colors may be exchanged for one anther by the user. In an alternative embodiment, the casing 22 may be securely fastened to the housing 20 to minimize user removal of the casing 22. The casing 22 may be a sheathing or wrapper that fully or partially encases the housing 20. In some embodiments, the casing 22 may resemble a “skin” or membrane that is present over the housing 20.

In the illustrated embodiment, the casing 22 has an opening through which the display 14 and keypad 18 are exposed. In other embodiments, the casing 22 may cover the display 14 and/or the keypad 18. In still other embodiments, multiple openings may be provided to separately expose various components. For instance, the openings may individually expose the keys of the keypad 18. Other openings may expose a speaker 24 and a microphone 26.

In other embodiments, the casing 22 and the housing 20 may be integrally formed. In one implementation, the casing 22 may replace portions of the housing 20 so that the mobile telephone 10 is partially opaque, and partially clear or translucent.

The mobile telephone 10 may further include an illuminator assembly 28 (FIG. 2). In one embodiment, the illuminator assembly 28 includes a set of illuminators 30 (FIG. 1) that are controlled to illuminate in accordance with operation of the attribute function 12. The illuminators 30 may be light emitting diodes (LEDs), lights, small liquid crystal displays (LCDs) and so forth. In one embodiment, the illuminators 30 protrude through or are exposed by openings in the housing 20, but are located under the casing 22 so that light from the illuminators 30 shines through the casing 22, and/or is diffused or guided around the mobile telephone 10 by the casing 22.

The illuminators 30 may be controlled to emit light of different colors to give the mobile telephone 10 different appearances, or physical attributes. For instance, each illuminator 30 may be controlled to make it appear as if the mobile telephone 10 is glowing in a specified color, such as blue, red, yellow, orange, green, and so forth. To achieve the various colors, multi-color illuminators 30 may be provided and/or individually controllable illuminators 30 of difference colors may be provided. The illuminators 30 may be collectively controlled to flash or pulse, may be controlled to emit different colors at the same time, and create other illumination effects. The generation of light may be controlled so that the color progressively changes from one color to another and/or moves or circulates about the mobile telephone 10. The illuminators 30 may be controlled in coordination with other light producing components of the mobile telephone 10, such as backlighting of the keypad 18 and/or content displayed on the display 14.

FIG. 3 represents another embodiment of a mobile telephone 10 with changeable attributes. The block diagram of FIG. 2 applies to the mobile telephone 10 embodiment of FIG. 3 in the same manner that the block diagram of FIG. 2 applies to the mobile telephone 10 embodiment of FIG. 1. The mobile telephone 10 of FIG. 3 has a clear or translucent housing 20. In other embodiment, the housing 20 may be opaque in selected areas. Illuminators 30 located under clear or translucent portions of the housing 20 may be controlled to emit light of different colors to give the mobile telephone 10 different appearances, or physical attributes, in a similar manner to the mobile telephone 10 of FIG. 1.

The keypad 18 of the mobile telephone 10 of FIG. 3 may be a touch sensitive keypad 32. For instance, the touch sensitive keypad 32 may be a capacitive keypad assembly that has regions corresponding to different functions or input values. Indicia may be present to delineate the various functional regions and to specify the corresponding functions or input values. In one embodiment, a touch sensitive member or assembly that is at least partially transparent is disposed over a liquid crystal display (LCD) that generates the indicia and controls the color of the indicia and/or background. In one embodiment, the LCD may be a bi-stable LCD controlled in combination with front lighting or backlighting. The color scheme of the keypad 32 may be varied under the control of the attribute function 12. It will be appreciated that the indicia may be made to change color against a static color background, the indicia may be a static color (e.g., black) and the background may be changeable in color, or the indicia and the background may be separately changeable in color. It will be further appreciated that the keypad 32 may be used in mobile telephones that do not include a changeable lighting arrangement for the body of the mobile telephone (e.g., as made possible by the housing 22 of FIG. 3 and/or the casing 22 of FIG. 1 in combination with the illuminators 30).

In other embodiments, color attributes of at least a portion of the mobile telephone 10 may be established by controlling a display (e.g., an LCD) that is located under a translucent member. In this embodiment, the display may be part of the illuminator assembly 28 and may be separate from the display 14 used to present information (e.g., text and graphics) to the user.

As indicated, FIG. 2 is a functional block diagram that may be considered to represent the mobile telephone 10 of both FIGS. 1 and 3. For the sake of brevity, generally conventional features of the mobile telephone 10 will not be described in great detail herein. The mobile telephone 10 includes a primary control circuit 34 that is configured to carry out overall control of the functions and operations of the mobile telephone 10. The control circuit 34 may include a processing device 36, such as a CPU, microcontroller or microprocessor. The processing device 36 executes code stored in a memory (not shown) within the control circuit 34 and/or in a separate memory, such as the memory 16, in order to carry out operation of the mobile telephone 10. The memory 16 may be, for example, one or more of a buffer, a flash memory, a hard drive, a removable media, a volatile memory, a non-volatile memory, a random access memory (RAM), or other suitable device.

In addition, the processing device 36 may execute code that implements the attribute function 12. It will be apparent to a person having ordinary skill in the art of computer programming, and specifically in application programming for mobile telephones or other electronic devices, how to program a mobile telephone 10 to operate and carry out logical functions associated with the attribute function 12. Accordingly, details as to specific programming code have been left out for the sake of brevity. Also, while the attribute function 12 is executed by the processing device 36 in accordance with a preferred embodiment of the invention, such functionality could also be carried out via dedicated hardware, firmware, software, or combinations thereof, without departing from the scope of the invention.

Continuing to refer to FIGS. 1 to 3, the mobile telephone 10 includes an antenna 38 coupled to a radio circuit 40. The radio circuit 40 includes a radio frequency transmitter and receiver for transmitting and receiving signals via the antenna 38 as is conventional. The radio circuit 40 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 10 further includes a sound signal processing circuit 42 for processing audio signals transmitted by and received from the radio circuit 40. Coupled to the sound processing circuit 42 are the speaker 24 and the microphone 26 that enable a user to listen and speak via the mobile telephone 10 as is conventional. The radio circuit 40 and sound processing circuit 42 are each coupled to the control circuit 34 so as to carry out overall operation. Audio data may be passed from the control circuit 34 to the sound signal processing circuit 42 for playback to the user. The audio data may include, for example, audio data from an audio file stored by the memory 16 and retrieved by the control circuit 34, or received audio data such as in the form of streaming audio data from a mobile radio service. The sound processing circuit 42 may include any appropriate buffers, decoders, amplifiers and so forth.

The display 14 may be coupled to the control circuit 34 by a video processing circuit 44 that converts video data to a video signal used to drive the display 14. The video processing circuit 44 may include any appropriate buffers, decoders, video data processors and so forth. The video data may be generated by the control circuit 34, retrieved from a video file that is stored in the memory 16, derived from an incoming video data stream that is received by the radio circuit 40 or obtained by any other suitable method.

The mobile telephone 10 may further include one or more I/O interface(s) 46. The I/O interface(s) 46 may be in the form of typical mobile telephone I/O interfaces and may include one or more electrical connectors. As is typical, the I/O interface(s) 46 may be used to couple the mobile telephone 10 to a battery charger to charge a battery of a power supply unit (PSU) 48 within the mobile telephone 10. In addition, or in the alternative, the I/O interface(s) 46 may serve to connect the mobile telephone 10 to a headset assembly (e.g., a personal handsfree (PHF) device) that has a wired interface with the mobile telephone 10. Further, the I/O interface(s) 46 may serve to connect the mobile telephone 10 to a personal computer or other device via a data cable for the exchange of data. The mobile telephone 10 may receive operating power via the I/O interface(s) 46 when connected to a vehicle power adapter or an electricity outlet power adapter.

The mobile telephone 10 also may include a system clock 40 for clocking the various components of the mobile telephone 10, such as the control circuit 20. The control circuit 20 may, in turn, carry out timing functions, such as timing the durations of calls, generating the content of time and date stamps, and so forth.

The mobile telephone 10 may include a camera 52 for taking digital pictures and/or movies. Image and/or video files corresponding to the pictures and/or movies may be stored in the memory 16.

The mobile telephone 10 also may include a position data receiver 54, such as a global positioning system (GPS) receiver, Galileo satellite system receiver or the like. The position data receiver 54 may be involved in ascertaining the location of the mobile telephone 10. The determination of the location of the mobile telephone 10 will be described in greater detail below.

The mobile telephone 10 also may include a local wireless interface 56, such as an infrared transceiver and/or an RF interface (e.g., a Bluetooth interface), for establishing communication with an accessory, another mobile radio terminal, a computer or another device. For example, the local wireless interface 56 may operatively couple the mobile telephone 10 to a headset assembly (e.g., a PHF device) in an embodiment where the headset assembly has a corresponding wireless interface.

With additional reference to FIG. 4, the mobile telephone 10 may be configured to operate as part of a communications system 58. The system 58 may include a communications network 60 having a server 62 (or servers) for managing calls placed by and destined to the mobile telephone 10, transmitting data to the mobile telephone 10 and carrying out any other support functions. The server 62 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 60 may support the communications activity of multiple mobile telephones 10 and other types of end user devices. As will be appreciated, the server 62 may be configured as a typical computer system used to carry out server functions and may include a processor configured to execute software containing logical instructions that embody the functions of the server 62 and a memory to store such software.

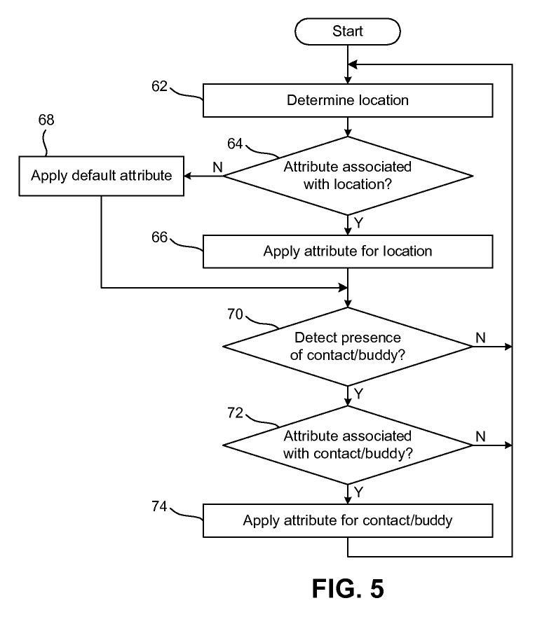

With additional reference to FIG. 5, illustrated are logical operations to implement an exemplary method of controlling the mobile telephone 10 to change physical properties of the mobile telephone 10 based on a location of the mobile telephone 10 and/or the presence of other electronic devices with respect to the mobile telephone 10. The exemplary method may be carried out by executing an embodiment of the attribute function 12, for example. Thus, the flow chart of FIG. 5 may be thought of as depicting steps of a method carried out by the mobile telephone 10. Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

The logical flow for the attribute function 12 may begin in block 62 where a location of the mobile telephone 10 is determined. The current location of the mobile telephone 10 may be determined using any appropriate positioning technology. For instance, the location determination mechanism may include accessing an identity of a communications access point (e.g., communications tower) servicing the mobile telephone 10. In one embodiment, the communications tower may be part of a cellular network (e.g., a “cell” tower) that has an associated identifier (e.g., “cell ID”) and the identifier is communicated to the mobile telephone 10 or the server 62 as an identifier or position. Each identifier or cell ID in a particular servicing network may be assumed to be unique and, therefore, may be used to indicate relative proximity to a certain location. In one embodiment, the cell ID and any related radio parameters may be used to generate a coordinate value through a radio network service. For example, under global system mobile communications (GSM) and universal mobile telecommunications system (UMTS) protocols, the position could be estimated through a mobile originated location request (MO-LR) to the network so that the mobile telephone 10 position could be estimated using the network's knowledge of tower locations and antenna directions.

In other embodiments, location information may be determined by receipt of location data from a dedicated system, such as a global positioning system (GPS), Galileo satellite system or the like. Such data may be received via the position data receiver 54, if present as part of the mobile telephone 10. GPS coordinates may be expressed using a standard reference system (e.g., the world geodetic system or WGS). Also, assisted-GPS (or A-GPS) may be used to determine the location of the mobile telephone 10. A-GPS uses an assistance server, which may be implemented with the server 62. The assistance server processes location related data and accesses a reference network to speed location determination and transfer processing tasks from the mobile telephone 10 to the server 62. For instance, the assistance server may perform tasks to make range measurements and calculate position solutions that would otherwise be carried out by the position data receiver 54 or elsewhere in the mobile telephone 10.

Following the location determination in block 62, the logical flow may proceed to block 64 where a determination is made as to whether an attribute is associated with the identified location. The attribute may be user assignable for the corresponding location. Also, an attribute may be configured to match a location if the mobile telephone 10 is within a specified distance from the location. Thus, correlation of an attribute and a location may be based on proximity of the mobile telephone 10 to the location or a determination that the mobile telephone 10 is physically at the specified position.

An exemplary attribute may be the color or colors generated by the illuminator assembly 28, inclusive of brightness, hue, flashing sequences, toggling or transitions between or among colors, and so forth. By way of example, the user may configure attributes so that a glowing neon yellow color is associated with the location of user's home and a conservative blue color is associated with the location of the user's workplace. Furthermore, the attribute may be configured to have a proximity relationship with the associated location. For instance, the exemplary yellow color associated with the user's home may be associated with all locations within a two mile radius from the user's home. The mobile telephone 10 may be configured to have different attributes based on a number of locations or regions, such as the user's home, the user's workplace, the user's school, a friend's home, an entertainment district near the user's home, an area associated with a specified city's limits (e.g., one color for when the mobile telephone 10 is in the city and another for when the mobile telephone 10 is outside the city), and so forth. Each of the specified locations may be associated with a color, a color pattern and other color related properties.

For each location or area specified by the user, a corresponding color or colors may be selected from a palette of colors that the illuminator assembly 28 (inclusive of the illuminators 30 and/or light generators associated with the keypad 18 and/or keypad 32) is capable of producing. Also selectable may be flashing patterns, gradations in hue, gradations in brightness and any other user-modifiable attribute parameter that is within the capacity of illuminator assembly 28 to produce. The associations of locations and user selected attribute values may be stored in an appropriate database structure, such as a look-up table.

In addition, the color generated by the illuminator assembly 28 may be coordinated with a navigation function of the mobile telephone 10 in an embodiment where the mobile telephone 10 is configured to provide the user with directions to a specified destination. In one embodiment, as the user starts traveling to the destination, the color may be an “icy blue” color. As the user, and hence the mobile telephone 10, progresses to the destination, the color of the mobile telephone may change to “warmer” blue tones, then to pink tones and, as the mobile telephone 10 nears the final destination, to a “hot red” color. In a variation of this embodiment, the color progression may be made for each intermediate direction from the starting location to the final destination. For instance, if the directions were to follow one street for two miles, then turn left onto a second street and travel on that street for five miles, the color may start as blue and progress to red during the two miles leading to the left turn. After turning left, the color of the mobile telephone 10 may return to the blue color and progressively transition to red during the next five miles of travel.

If an attribute has been associated with the current location of the mobile telephone 10 due to either the physical presence of the mobile telephone 10 at a specified place or within a specified proximity of a specified place, a positive determination may be made in block 64. Upon a positive determination in block 64, the logical flow may proceed to block 66. In block 66, the attribute associated with the current location of the mobile telephone 10 may be applied. For instance, if the attribute associated with the location is to generate green light with the illuminator assembly 28 to give the mobile telephone a green appearance, then the illuminator assembly 28 may be controlled to produce green light.

If there is no attribute associated with the current location of the mobile telephone 10, a negative determination may be made in block 64. Upon a negative determination in block 64, the logical flow may proceed to block 68. In block 68, a default attribute may be applied. The default attribute may be established by factory or vendor settings, or by user selection of a default attribute. In another embodiment, a previously applied location-related attribute may be maintained.

Following block 66 or block 68, the logic flow may proceed to block 70 where a presence detection is made. Presence detection is typically configured to determine if an electronic device 71 (e.g., another mobile telephone as depicted in FIG. 4) that is associated with a member of a user-populated “buddy list” or with a contact list entry is physically near the mobile telephone 10. Various methods of presence detection may be employed. For example, near field communication using radio frequency (RF) transponders and readers may be used to detect other electronic devices and receive a unique identifying value from the nearby electronic devices. If a received identifying value matches a previously known value, a determination may be made that an associated buddy or contact is nearby. Other wireless interfaces, such as Bluetooth, may be used in a similar manner to detect the presence of known electronic devices. In other embodiments, the communications network 60 may host a service to inform the mobile telephone 10 of the relative proximity of one or more electronic devices belonging to persons previously identified by the user of the mobile telephone 10. In an alternative embodiment, the mobile telephone 10 may be configured to detect availability of a buddy, contact or device rather than physical presence.

If a contact or buddy of the user is not detected in block 70, the logical flow may return to block 62 to continue to track the location of the mobile telephone 10 and, following operation of the ensuing logical blocks, continue to monitor for the presence of a contact or buddy. If a positive determination is made in block 70, the logical flow may proceed to block 72. In block 72, a determination may be made as to whether an attribute has been associated with the contact or buddy that was detected in block 70. In one embodiment, a color may be assigned to the buddy as part of the user's buddy list that is stored by the mobile telephone 10 or a color may be assigned to the contact as part of the user's contact list that is stored by the mobile telephone 10. Other attributes, such as flashing of the color, brightness of the color, combinations of colors and so forth also may be associated with the contact or buddy. If a negative determination is made in block 72, the logical flow may return to block 62.

If a positive determination is made in block 72, the logical flow may proceed to block 74 where the attribute associated with the contact or buddy is applied. For example, the illuminator assembly 28 may be controlled to generate a color corresponding to the buddy or contact. Following block 74, the logical flow may return to block 62. Additional logic may be added to detect the departure of a buddy or contact and to return the physical attributes of the mobile telephone 10 to attributes used before detection of the buddy or contact. In other embodiments, attributes may be assigned based on the number of detected buddies or contacts, rather than the identity of a buddy or a contact.

To conserve battery life, additional logic may be added to control the generation of light. For instance, illumination may be maintained for a predetermined amount of time following changes in location, detection of a contact or buddy, or the occurrence of a user action or other specified event (e.g., receipt of a call or message). Also, user actions or other operating conditions may turn on or off the attribute for the current location or detected buddy or contact. For instance, opening a clamshell style phone may turn on the attribute and closing the clamshell style phone may turn off the attribute. Also, depressing a key of the keypad 18 or touching the touch sensitive keypad 32 may turn on the attribute. In another example, the attribute may be turned on upon receipt of a call or message (e.g., electronic mail message, a text message, a multimedia message or an instant message).

Additional parameters may be used to determine a physical attribute of the mobile telephone 10. For example, time of day and/or day of the week may be used instead of or in combination with location and/or presence information to determine which physical attribute to use for the mobile telephone 10. For example, if the time is during the user's regular working hours, then the attribute associated with a work profile may be used or the attributes associated with the location of the user's workplace may be used. In this manner, a professional appearance to the mobile telephone may be generated during business hours, even if the user travels outside his or her ordinary workplace. Similarly, other appearances may be generated for other time segments, such as times during which the user tends to socialize, attend a class, wake up, and so forth.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A mobile telephone, comprising:
a radio circuit for establishing a call over a communications network;
a housing that retains the radio circuit; and
an illumination assembly retained by the housing and that is controlled to generate light in a color having a user specified relationship to a location of the mobile telephone.

2. The mobile telephone of claim 1, wherein the illumination assembly includes one or more illuminators disposed under a clear or translucent casing that at least partially covers the housing of the mobile telephone.

3. The mobile telephone of claim 1, wherein the illumination assembly includes one or more illuminators disclosed under a clear or translucent portion of the housing of the mobile telephone.

4. The mobile telephone of claim 1, wherein the illumination assembly includes a display disposed under a translucent member.

5. The mobile telephone of claim 4, wherein the display is a liquid crystal display.

6. The mobile telephone of claim 5, wherein the translucent member is touch sensitive and forms part of a touch-sensitive keypad.

7. The mobile telephone of claim 1, further comprising a position data receiver for determining the location of the mobile telephone.

8. The mobile telephone of claim 1, wherein the illumination assembly is further controlled to generate light in a color having a user specified relationship to an electronic device that is detected to be in relative proximity to the mobile telephone.

9. A method of controlling a physical attribute of a mobile telephone, comprising:
determining a location of the mobile telephone; and
generating light with an illumination assembly of the mobile telephone in a color having a user specified relationship to the location of the mobile telephone.

10. The method of claim 9, further comprising generating light with the illumination assembly in a color having a user specified relationship to an electronic device that is detected to be in relative proximity to the mobile telephone.

11. The method of claim 9, further comprising generating light with the illumination assembly in a color having a user specified relationship to a time of day.

12. A mobile telephone, comprising:
a radio circuit for establishing a call over a communications network;
a housing that retains the radio circuit; and
an illumination assembly retained by the housing and that is controlled to generate light in a color having a user specified relationship to an electronic device that is detected to be in relative proximity to the mobile telephone.

13. The mobile telephone of claim 12, wherein the color is based on an identity of a user associated with the electronic device.

14. The mobile telephone of claim 12, wherein the color is based on a number of electronic devices detected to be in relative proximity to the mobile telephone.

15. The mobile telephone of claim 12, wherein the illumination assembly includes one or more illuminators disposed under a clear or translucent casing that at least partially covers the housing of the mobile telephone.

16. The mobile telephone of claim 12, wherein the illumination assembly includes one or more illuminators disclosed under a clear or translucent portion of the housing of the mobile telephone.

17. A method of controlling a physical attribute of a mobile telephone, comprising:
detecting presence of an electronic device having a known identity; and
generating light with an illumination assembly of the mobile telephone in a color having a user specified relationship to the detected electronic device.

18. The method of claim 17, wherein the color is based on an identity of a user associated with the electronic device.

19. The method of claim 17, wherein the color is based on a number of known electronic devices detected to be in relative proximity to the mobile telephone.
